(19) United States
(12) Patent Application Publication
(10) Pub. No.: US 2009/0307364 A1
(43) Pub. Date: Dec. 10, 2009

(54) COMMUNICATION APPARATUS AND CONTROL METHOD

(75) Inventor: Masami Shimakura, Machida-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/472,196

(22) Filed: May 26, 2009

(30) Foreign Application Priority Data
Jun. 9, 2008 (JP) 2008-150843

(51) Int. Cl. G06F 15/16; G06F 12/08

(52) U.S. Cl. 709/230; 711/136; 711/E12.017; 711/E12.022

(57) ABSTRACT

In a communication apparatus for communicating based on a communication protocol, context information relating to a connection of the communication protocol is held and managed. The timer used in the communication protocol is used for time-count process, a notification of timeout of the timer is given in advance, and when the notification of timeout is given in advance, an instruction for pre-load is given so that the context information is stored in the cache memory. Thereby, upon timeout of the timer, the context information is stored in the cache memory.

### BACKGROUND OF THE INVENTION

1. Field of the Invention

The present invention relates to a communication apparatus which communicates based on a communication protocol and a control method.

2. Description of the Related Art

Among a group of protocols known as TCP/IP (Transmission Control Protocol/Internet Protocol), TCP is a main connection-type protocol. TCP forms a logic bidirectional channel between two network devices (referred to as ends) and is a protocol that enables delivery and reception of data between the two network devices on that channel. Furthermore, it provides services such as delivery guarantee, flow control, and congestion control of handled data.

In order to achieve delivery guarantee of handled data in TCP, if one end receives data, it sends back an acknowledgement to the other end. However, there are times when this acknowledgement disappears during the transmission. In order to deal with this problem, TCP performs monitoring by means of timers. That is, it starts a timer triggered by data transmission, and if an acknowledgement does not arrive within a predetermined period, it causes a timeout and the data is retransferred. This timer is referred to as a “retransfer timer”.

Furthermore, TCP performs flow control called a “sliding window protocol” in order to smoothly perform data transmission. After each acknowledgement, one end notifies the other end of the amount of data it can receive, and the other end sends data in an amount within that data amount range, thereby allowing smooth data transmission.

However, in a state in which the receiving area of one end is full due to processing delays and data cannot be received (referred to as “receiving window closed”), notification of the window size is given as zero. The other end that received the zero notification ceases transmission until it receives a non-zero notification. However, if the non-zero notification disappears during the transmission, both ends continue to be in a waiting state in which communication is stopped.

In order to avoid this situation, a method called “window inspection” is used in TCP, in which an end that received a zero notification periodically queries the other end as to whether the window has enlarged or not. In order to assist this periodical operation, a timer called a “continuance timer” is started.

TCP realizes various services using the acknowledgement described above. However, each acknowledgement that was generated suppresses line capacity and increases the processing load at both ends. Therefore, TCP solves this problem with delayed acknowledgement. That is, it returns an acknowledgement once every several times, rather than at every reception, and thereby, it improves process efficiency and line capacity.

However, in an implementation which returns an acknowledgement based on the number of received segments, when a segment is lost, a state of waiting continues indefinitely. To deal with this problem, a timer called a “delayed acknowledgement timer” is started to prevent disruption of the communication.

While TCP provides a highly reliable service with the above-described various functions, it uses several types of timers to realizes its features and to avoid disruption of communications.

In recent years, the number of embedded appliances that is enabled for TCP/IP for connecting to networks is increasing and is enhancing the convenience of the user. In such circumstances, embedded appliances are also required to process network protocols faster.

It is said that a processor with an operating frequency of about 3 GHz is required to achieve Full-Wire speed of Gigabit Ethernet. This is far beyond the performance of processors generally equipped in today's embedded appliances. Therefore, it is popular to add to the system auxiliary devices specialized for protocol processing, such as TOE (TCP/IP Offload Engine), for achieving broadband network communications.

Japanese Patent Laid-Open No. 2002-524005 discloses a prior art TOE.

How to handle PCB information is a key for increasing speed in protocol processing, in particular, in TCP processing. PCB is an acronym for Protocol Control Block and represents context information and an aggregate thereof necessary to process communication protocols.

As represented by the Japanese Patent Laid-Open No. 2002-524005, in most TOE implementations, an increase in access speed is achieved by holding PCB information needed for TCP process in a high-speed primary memory (cache) such as an SRAM after copying it from the main memory.

Furthermore, in the Japanese Patent Laid-Open No. 2002-524005, if the primary memory could not hold all of the PCB information due to increase in the number of connections, a process for swapping between the primary memory and the main memory is performed according to the usage.

However, in TCP processing after a timeout has occurred in the above-described timer monitoring of TCP, occurrence of the timeout itself is not frequent so the effect of the cache is nearly eliminated.

A sudden decrease in performance caused by a timeout of TCP processing is becoming an important issue as the speed of communications media is increasing.

### SUMMARY OF THE INVENTION

The present invention provides a communication apparatus that can lessen a sudden decrease in performance upon timeout of a timer used in a communication protocol.

According to an aspect of the invention, a communication apparatus for communicating based on a communication protocol, comprising: a unit that holds and manages context information related to a connection of the communication protocol; a unit that performs a time-count process of a timer used in the communication protocol and pre-detects a timeout of the timer; and a unit that instructs a pre-load such that the context information is stored in a cache memory in a case where the timeout is pre-detected is provided.

According to another aspect of the invention, a method of controlling a communication apparatus for communicating based on a communication protocol, comprising: holding and managing context information concerning a connection of the communication protocol; performing a time-count process of a timer used in the communication protocol and pre-detecting a timeout of the timer; and instructing a pre-load such that the context information is stored in a cache memory in a case where the timeout is pre-detected is provided.

Further features of the present invention will become apparent from the following description of exemplary embodiments with reference to the attached drawings.

### BRIEF DESCRIPTION OF THE DRAWINGS

FIG. 1 depicts a block diagram showing an example of an arrangement of a communication apparatus according to the present embodiment of the invention.

FIG. 2 depicts a diagram showing an example of an internal structure of a TOE sub-system 105 shown in FIG. 1.

FIG. 3 depicts a diagram illustrating a role of a plurality of sub-processors in the TOE sub-system.

FIG. 4 depicts a diagram showing an example of an arrangement of a PCB control unit in the TOE sub-system.

FIG. 5 depicts a diagram showing an example of an internal format of CAM 207 according to the present embodiment of the invention.

FIG. 6 depicts a diagram showing an example of an internal format of CAM 208 according to the present embodiment of the invention.

FIG. 7 depicts a chart showing an excerpt of each element of TCPCB according to the present embodiment of the invention.

FIG. 8 depicts a diagram showing a format of TCPCB arranged according to size.

FIG. 9 depicts a diagram showing a group of TCPCB arranged in the main memory.

FIG. 10 depicts a diagram showing each TCPCB arranged in a PCB cache memory 211.

FIG. 11 depicts a diagram showing an example of an arrangement of a communication timer according to the present embodiment of the invention.

FIG. 12 depicts a diagram showing data format of an event FIFO that resides in a time-count processing unit according to the present embodiment of the invention.

FIG. 13 depicts a diagram showing a format of a timer initial value according to the present embodiment of the invention.

FIG. 14 depicts a diagram showing a format of a timer count value according to the present embodiment of the invention.

FIG. 15 depicts a diagram showing a relationship between resolutions and time values of a time-base that resides in the time-count processing unit according to the present embodiment of the invention.

FIG. 16 depicts a flow chart showing a time-count process of the communication timer according to the present embodiment of the invention.

FIG. 17 depicts a diagram showing a format of a table for timer count values according to the present embodiment of the invention.

FIG. 18 depicts a flow chart showing an event notifying process according to the present embodiment of the invention.

FIG. 19 depicts a flow chart showing an exponential backoff process according to the present embodiment of the invention.

FIGS. 20A and 20B depict a flow chart showing a pre-load process according to the present embodiment of the invention.

FIG. 21 depicts a diagram showing a bitmap representing use/not-in-use of socket numbers allocated on a PCB management table according to the present embodiment of the invention.

FIG. 22 depicts a diagram showing a bitmap representing use/not-in-use of cache block numbers allocated on the PCB management table according to the present embodiment of the invention.

FIG. 23 depicts a diagram showing a format of concatenated blocks in an LRU table according to the present embodiment of the invention.

FIG. 24 depicts a diagram showing a format of an LRU table, and a relationship between concatenated blocks, a start pointer and an end pointer in the LRU table.

FIG. 25 depicts a diagram showing an address conversion of the PCB cache memory control unit 407 according to the present embodiment of the invention.

### DESCRIPTION OF THE EMBODIMENTS

Hereinafter, a detailed description of a preferred embodiment of the invention will be given with reference to the drawings.

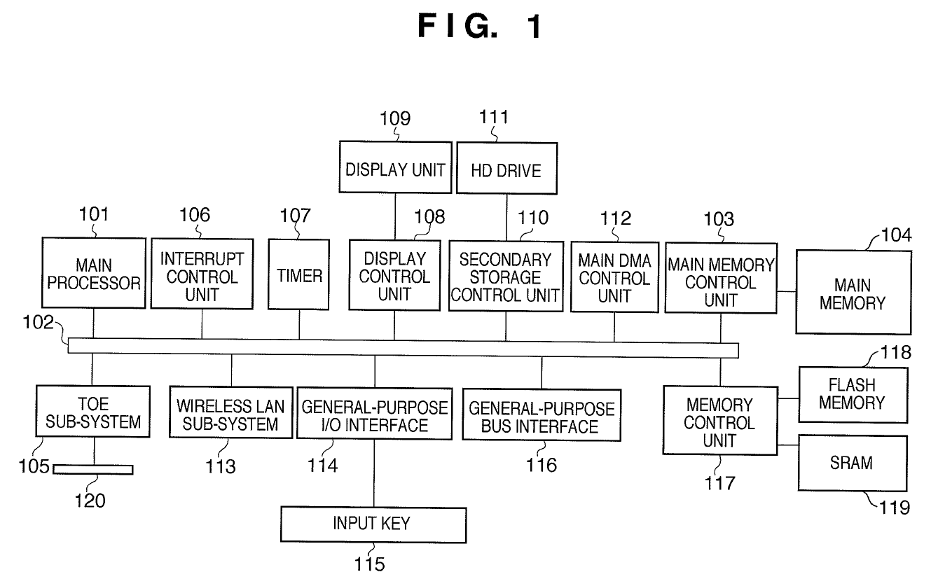

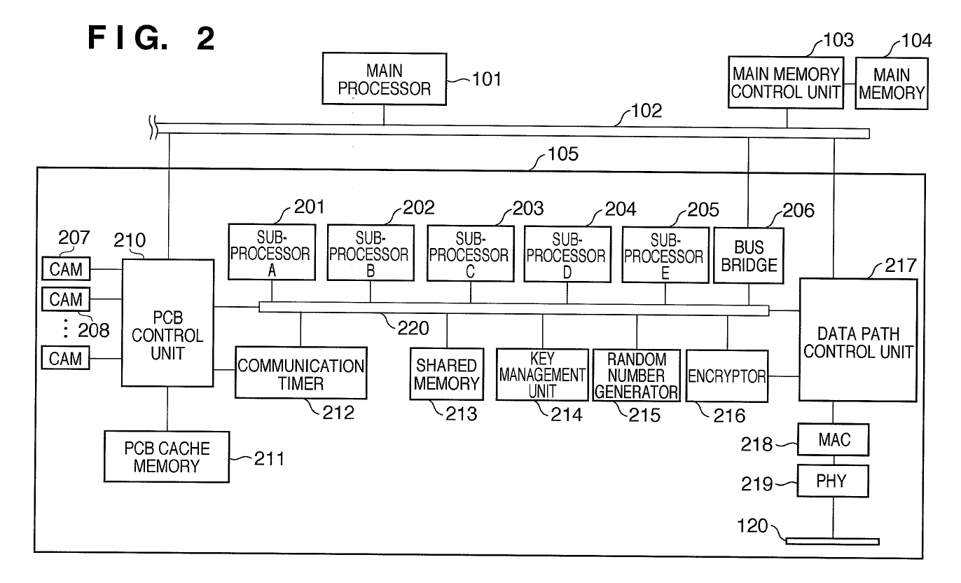

An arrangement of a communication apparatus including a TOE sub-system will be described with reference to FIGS. 1 and 2. TOE is an acronym for TCP/IP (Transmission Control Protocol/Internet Protocol) Offload Engine.

FIG. 1 depicts a block diagram showing an example of an arrangement of a communication apparatus according to the present embodiment of the invention. As shown in FIG. 1, the communication apparatus includes units 101, 103, 105-108, 110, 112-114, 116, and 117, and each of the units are connected via a system bus 102. It is noted that the system bus 102 is an on-chip bus with a cross-bar switch structure and is able to perform parallel transferring operations of transmitting and receiving data, which are required for the communication apparatus. The on-chip bus complies with AMBA 3.0, which is an on-chip bus standard in which AXI (Advanced extensible Interface) protocol is added.

The main processor 101 executes a boot program in the flash memory 118 upon power-on. Furthermore, after initializing individual hardware and sub-systems, it loads software stored in the HD (hard disk) drive 111 on the main memory 104, and starts an OS (operating system) included in the software. The main memory control unit 103 controls access to the main memory 104.

The TOE sub-system 105 controls data communications with external networks connected by Ethernet (registered trademark) 120. The detailed arrangement and operations of the TOE sub-system 105 will be further described below.

When an interrupt event occurs in individual hardware, the TOE sub-system 105, and the wireless LAN sub-system 113, the interrupt control unit 106 notifies the main processor 101 of the interrupt event according to a predetermined priority order.

The timer 107 is started by software, etc., and triggers time measurement and timeout events. The display control unit 108 controls the display unit 109 for displaying conditions and settings of application software.

The secondary storage control unit 110 controls access to the HD drive 111. Software and related data for enabling functions of the communication apparatus, and microcodes and related data that operate on sub-processors and sequencers in the individual sub-systems are stored in the HD drive 111. Further, communication data and history information such as operation history and communication history of the communication apparatus are stored in the HD drive 111.

The main DMA control unit 112 controls data transfer between the main processor 101 and the main memory 104 and between memories.

The wireless LAN sub-system 113 provides a wireless LAN function that complies with IEEE802.11a/b/g/n standards. The general-purpose I/O interface 114 is an interface with the input key 115 for inputting operation mode settings of the communication apparatus and communication parameters such as IP addresses.

The general-purpose bus interface 116 is an interface for general-purpose buses, such as PCI (Peripheral Component Interconnect). PCI is an industry standard general-purpose bus formulated by PCI Special Interest Group.

The memory control unit 117 controls access to the flash memory 118, which is a rewritable non-volatile memory, and to the SRAM 119, which is a high-speed primary memory (cache).

It is noted that the flash memory 118 stores a boot program that runs at startup and parameters needed for setting initial conditions. Furthermore, device drivers for controlling individual hardware at startup and setting parameters for starting up individual hardware, etc., are stored in the flash memory 118.

FIG. 2 depicts a diagram showing an example of an internal structure of the TOE sub-system 105 shown in FIG. 1. Sub-processors A201-E205, a bus bridge 206, a PCB control unit 210, a communication timer 212, a shared memory 213, a key management unit 214, a random number generator 215, an encryptor 216, and a data-path control unit 217 are connected to a sub-system bus 220. The sub-system bus 220 provides cross-bar switch connections.

First, the sub-processors A201-E205 execute TCP/IP protocol processing off-loaded from the main processor side. The firmware that the sub-processors A201-E205 execute is expanded onto the main memory 104 upon initialization of the TOE sub-system 105 and is loaded onto a respective instruction cache memory that includes firmware, and is then executed.

The bus bridge 206 connects the system bus 102 at the main side and the sub-system bus 220.

The PCB control unit 210 performs generation and deletion, access control, and maintenance of PCB, which represents context information and its aggregate needed to process communication protocols. PCB is an acronym for Protocol Control Block. Details of the PCB control unit 210 will be further described below.

The PCB control unit 210 is connected to a PCB caching memory 211, which temporarily holds PCB for enabling reference or rewriting from the sub-processors A201-E205 in a short time.

Furthermore, the PCB control unit 210 is connected to a plurality of CAM (Content Addressable Memory) 207-208. The CAM 207 is a memory for use in searches for the purpose of identifying PCBs, using information retrieved from the received frame as search keys. Moreover, the CAM 208 is a memory for determining whether the desired PCB exists in the PCB cache memory 211 or not. That is, when the data for the search key and the data registered in the CAM match, the CAM reports the address information where the data is stored as the search result.

It is noted that when there is a plurality of identical data in the CAM, all of them are reported, but there is no such case in the present embodiment of the invention. Details of the CAMs 207-208 will be further described below.

The communication timer 212 triggers time measurement and generates timeout events that are needed for processing the TCP/IP protocol. The shared memory 213 is a memory for sharing communication and information among the sub-processors A201-E205. The key management unit 214 securely holds encryption keys, random numbers and prime numbers that are generated for processing encryption communication protocols. The random number generator 215 generates random numbers for processing the TCP/IP protocol and the encryption communication protocol.

The encryptor 216 performs an encryption process needed for processing encryption communication protocols, such as IPsec and SSL/TLS. Furthermore, it includes AES (Advanced Encryption Standard) encryptor adopted by the United States National Institute of Standards and Technology (NIST). Moreover, it includes SHA-1 (Secure Hash Algorithm 1) hash function unit used in certification and digital signature, etc., and MD5 (Message Digest 5) hash function unit standardized as RFC-1321 at IETF.

The MAC (Media Access Control) 218 is hardware that handles protocol processing in the MAC Layer, which corresponds to the Data Link Layer (Layer 2) of the OSI Reference Model. The PHY (Physical Layer Chip) 219 is hardware that handles protocol processing and electric signals in the PHY (Physical) Layer, which corresponds to Layer 1 of the OSI Reference Model.

The data path control unit 217 includes a buffer memory for temporarily holding data for transmission, a controller for controlling the buffer memory, a DMA control unit for transferring data, and a checksum computing unit for computing checksums during the DMA process.

Specifically, it includes a receiving buffer memory for temporarily holding a received frame processed in the MAC 218, and a receiving buffer memory controller that enables sub-processors A201-E205 to refer to protocol headers of each layer in the received frame. Furthermore, it includes a transmitting buffer memory for temporarily holding data for transmission, and a transmitting buffer memory controller that enables the sub-processors A201-E205 to form protocol headers of each layer into the data for transmission. The DMA control unit performs data transfer between the transmitting and receiving buffer memories and the main memory 104, and between the transmitting and receiving buffer memories and the MAC 218.

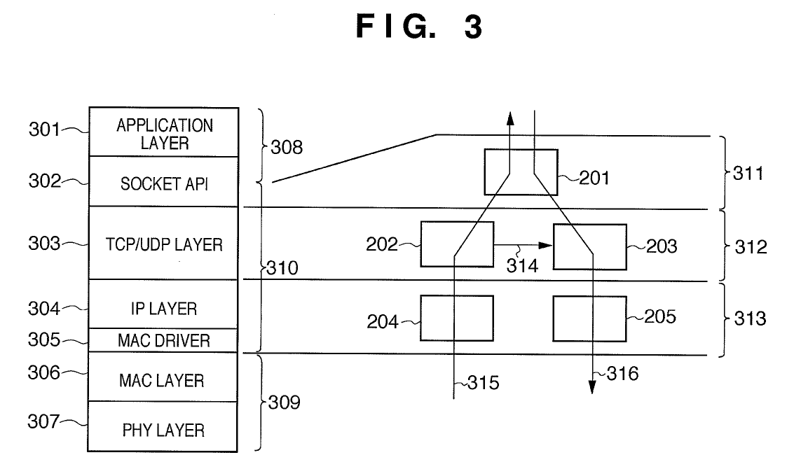

The role of the sub-processors A201-E205 in the TOE sub-system 105 will be described with reference to FIG. 3.

FIG. 3 depicts a diagram illustrating a role of a plurality of sub-processors in the TOE sub-system. The processing function of the TOE sub-system 105 covers functions of the MAC driver 305 that exchanges communication data and communication information with the MAC layer 306. Further, it covers a part of the functions of the Internet Layer (IP Layer) 304 that processes IP protocol, Transport Layer (TCP/UDP Layer) 303 that processes TCP and UDP protocols, and socket API 302. These functions cover a range 310 shown in FIG. 3 that selects protocols and relays data passing and information transmission.

As shown in FIG. 3, these functions are distributed to the sub-processors A201-E205 to be processed. For example, a process for socket API 302 is assigned to the sub-processor A201. Moreover, among the processes for TCP and UDP protocols, a process relating to the receiving operation is assigned to the sub-processor B202, and a process relating to the transmitting operation is assigned to the sub-processor C203. Furthermore, among the processes for the MAC driver 305 and IP protocol, a process relating to the receiving operation is assigned to the sub-processor D204, and a process relating to the transmitting operation is assigned to the sub-processor E205.

It is noted that the intention of the distribution is to distribute this series of protocol processing into three pipeline stages 311-313 and to perform a pipeline operation. Further, by means of distributing the transmitting operation and the receiving operation, the sub-processors in charge of the respective operations are able to operate in parallel.

In TCP, the beginning of a formation of a logic channel is called “connection establishment” and its end is called “connection release”. The period between the connection establishment and the connection release is called the “established state” or “connection state”, or simply, “a connection”.

A plurality of connections can be formed between two network devices, and a plurality of connections can be formed with another plurality of network devices. A connection is represented by four pieces of information, that is, IP addresses and TCP port numbers for both of the two network devices. Such a combination of information is called “socket pair information” or “socket information”. The TCP header for each TCP packet transmitted and received after the connection establishment includes the socket information.

From a viewpoint of guaranteeing delivery of the transferring data, TCP conveys delivery confirmation information called “acknowledgement” from the receiving side to the transmitting side across the connection. In order to perform the process for the acknowledgement, conveyance 314 of delivery confirmation information is needed between the sub-processor B202 and the sub-processor C203.

Such information conveyance and information sharing, the information conveyance and information sharing between pipeline stages, and the information conveyance and information sharing between sub-processors A201-E205 and the main processor 101 that configure the pipeline stages are performed via the shared memory 213. Of course, these information conveyance and information sharing may be performed using the main memory 104.

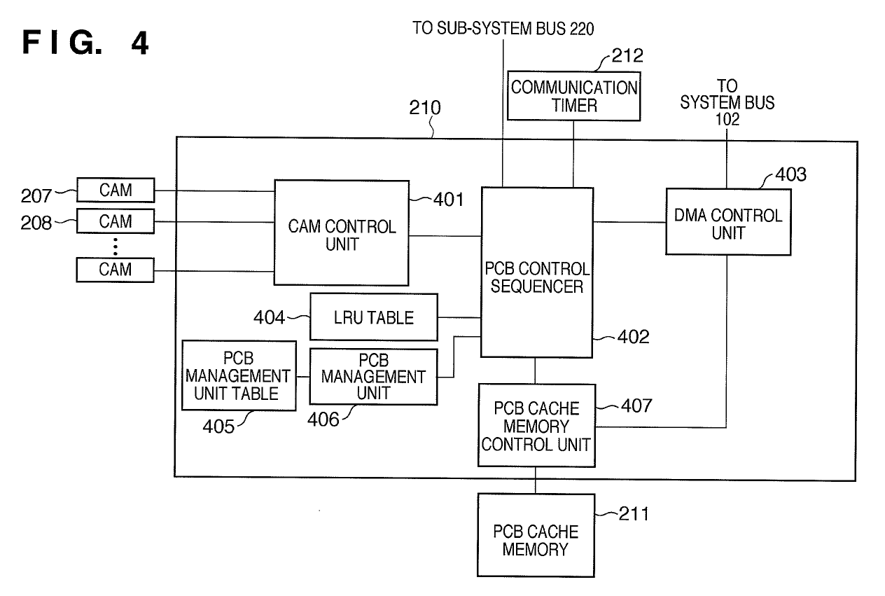

In the following, an arrangement of the PCB control unit 210 in the TOE sub-system 105 and details of the CAMs 207-208 will be described with reference to FIGS. 4-10.

FIG. 4 depicts a diagram showing an example of an arrangement of a PCB control unit in the TOE sub-system. The PCB control unit 210 includes a CAM control unit 401 for controlling CAMs 207-208, a PCB control sequencer 402 for controlling the whole PCB control unit 210, and a DMA control unit 403 for performing data transfer between the PCB cache memory 211 and the main memory 104. Furthermore, it includes an LRU table 404, a PCB management unit table 405 for managing PCB, a PCB management unit 406 for managing the PCB management unit table 405, and a PCB cache memory control unit 407 for controlling the PCB cache memory 211.

It is noted that the PCB control sequencer 402 performs control according to the microcode loaded onto an internal instruction memory. The PCB control sequencer 402 is configured as a programmable sequencer in the present embodiment of the invention, but it may be hardware configured with a finite state machine so as to enhance the speed.

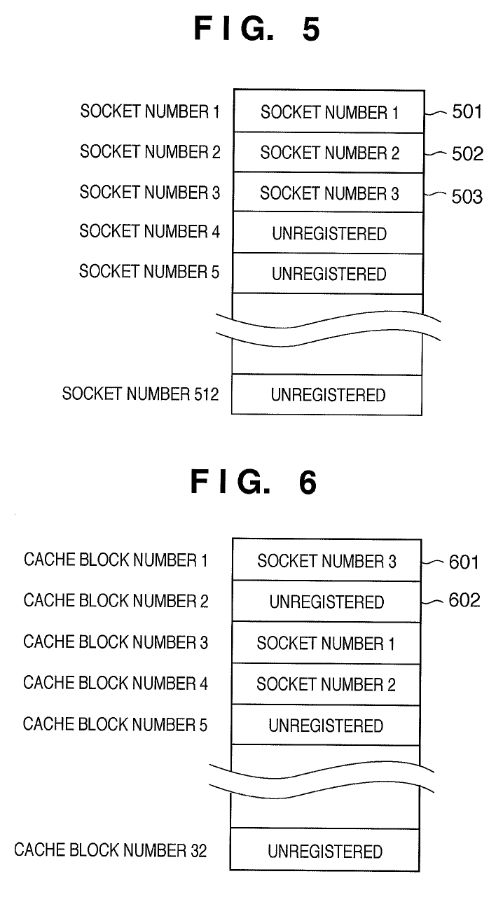

FIG. 5 depicts a diagram showing an example of an internal format of the CAM 207 according to the present embodiment of the invention. In the example shown in FIG. 5, three pieces of socket information 1-3 that were registered upon the TCP connection establishment are registered in areas 501-503 of socket numbers 1-3.

Moreover, the socket information, the socket number, and the PCB are associated one by one. As shown in FIG. 6, the cache block number on the PCB cache memory 211 in which the PCB is registered is indicated by the existence of the registration of the socket number.

FIG. 6 depicts a diagram showing an example of an internal format of the CAM 208 according to the present embodiment of the invention. In the example shown in FIG. 6, socket number 3 is registered at area 601 of the cache block number 1, and the area 602 of the cache block number 2 is unregistered.

In other words, the socket number can be obtained by searching the CAM 207 using socket information retrieved from the receiving frame as a search key. By searching the CAM 208 using the acquired socket number, whether the PCB exists in the PCB cache memory 211 or not can be known, and if it does, the cache block number on which the PCB is registered can be known.

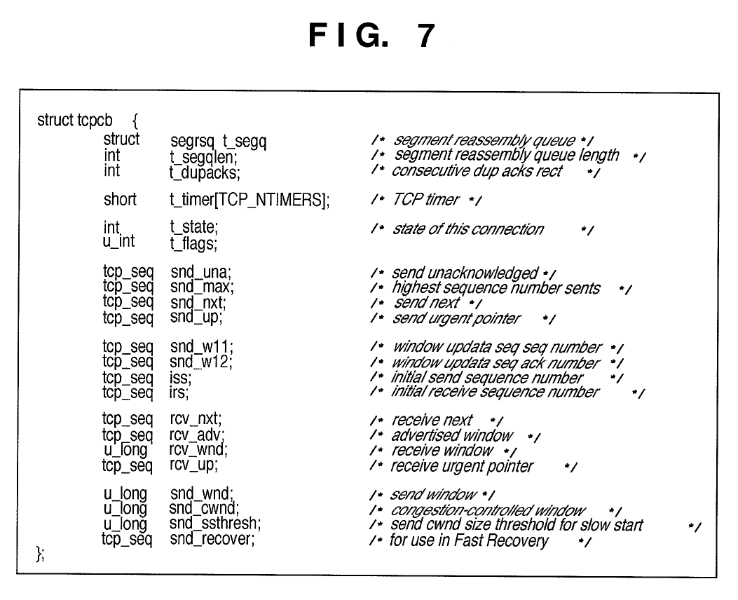

PCB is also abbreviated as TCPCB in the context of a TCP process. FIG. 7 depicts a chart showing an excerpt of each element included in this TCPCB. In FIG. 7, parameters having the prefix “snd_” are transmitting parameters, and parameters having the prefix “rcv_” are receiving parameters.

Although not shown in FIG. 7, it is noted that various elements exist, such as the destination IP address, destination port number, source IP address, and source port number. Furthermore, TCPCB has a size of about 2 kilobits per connection.

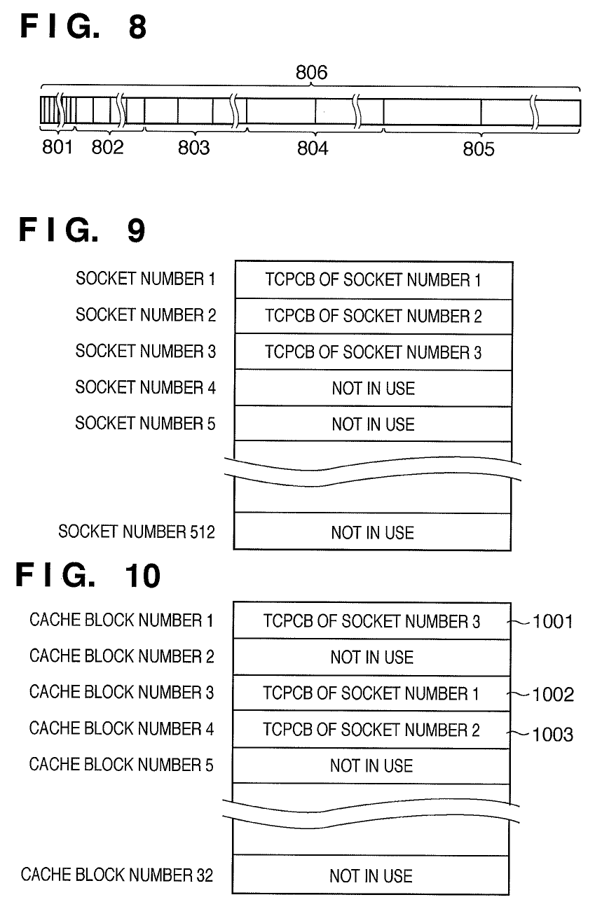

As shown in FIG. 8, during the TCP/IP protocol processing, TCPCBs are organized and allocated by the size of elements, such as 1-bit elements 801, 4-bit elements 802, 8-bit elements 803, 16-bit elements 804, and 32-bit elements 805. Elements are normalized to match one of these sizes. Furthermore, such segmentation by size is a logical segmentation that the TOE firmware distinguishes. Individual sizes, the number of elements, and the order of elements may be redefined with the description in a header file in which various parameters used during compilation of the TOE firmware are included. Furthermore, as shown in FIG. 9, the TCPCB groups 806 allocated in the main memory 104 are lined up and stored in an order of socket numbers that distinguish TCP connections.

During the TCP/IP protocol processing, TCPCBs are accessed from the sub-processor A201, the sub-processor B202, and the sub-processor C203. In order to smoothly perform the access, each TCPCB is duplicated in the PCB cache memory 211 at a timing when the sub-processors A201-C203 access.

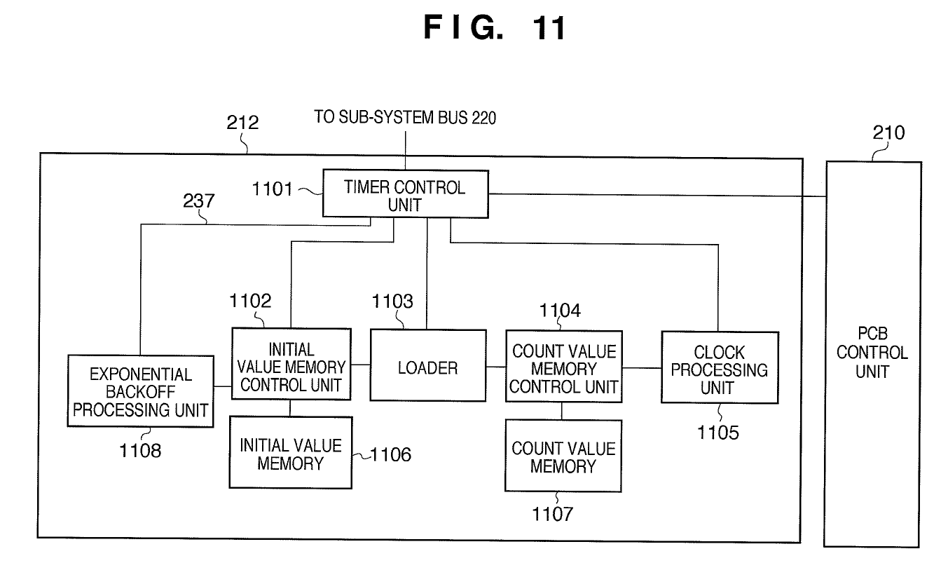

FIG. 10 depicts a diagram showing each TCPCB arranged on the PCB cache memory 211. In this example, the TCPCB to be accessed is duplicated in areas 1001, 1002, 1003 of the cache block numbers 1, 3, 4 in the PCB cache memory 211. However, in case of TCPCBs generated for a new TCP connection, it may be in the PCB cache memory 211 and may not be evacuated into the main memory 104.

The TCPCB transfer between the PCB cache memory 211 and the main memory 104, such as evacuation, is performed by the DMA control unit 403 under the direction of the PCB control sequencer 402.

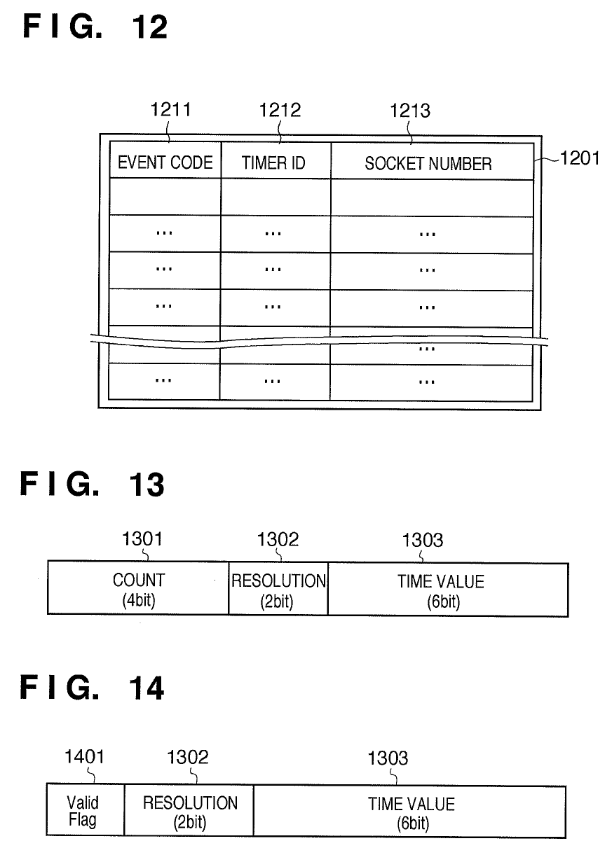

In TCP, several types of timers other than the three above-described timers are individually run for each connection (for each socket). In the following, an arrangement of the communication timer 212 according to the present embodiment of the invention, in which the above timers are organized, will be described with reference to FIGS. 11-15.

FIG. 11 depicts a diagram showing an example of an arrangement of a communication timer according to the present embodiment of the invention. As shown in FIG. 11, the communication timer 212 is comprised of a timer control unit 1101 that controls an overall communication timer 212 and functions as an interface (I/F) with external elements. It is further comprised of an initial value memory 1106 for holding a timer initial value for each timer and for each connection, and an initial value memory control unit 1102 for writing and reading the initial value.

Furthermore, it is comprised of a count value memory 1107 for holding values for intermediate progress during operation of the timer, and a count value memory control unit 1104 for writing and reading the count value. Moreover, it is comprised of a loader 1103 for transferring an initial value of the timer and the connection specified in an instruction of the timer control unit 1101 from the initial value memory 1106 to the count value memory 1107.

Further, it is comprised of a clock processing unit 1105 for performing determination by reading the timer count value stored in the count value memory 1107 in a predetermined cycle and for performing a process for writing back the updated result. Furthermore, it is comprised of an exponential backoff processing unit 1108 for updating the timer initial value upon timeout by doubling it.

The timer initial value indicates a value for a timeout period set in the timer upon triggering the timer. The clock processing unit 1105 holds the determined result in its internal event FIFO as event information and conveys it to the timer control unit 1101.

FIG. 12 depicts a diagram showing the data format of an event FIFO built in the time-count processing unit according to the present embodiment of the invention. The event information 1201 consists of event codes 1211 that indicate events, such as timeouts, timer IDs 1212 that indicate timer types (e.g., retransfer timer, continuation timer, delayed acknowledgement timer), and socket numbers 1213 that indicate types of connections.

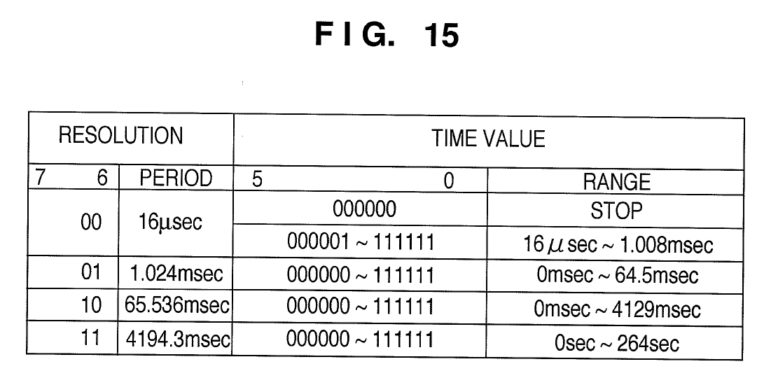

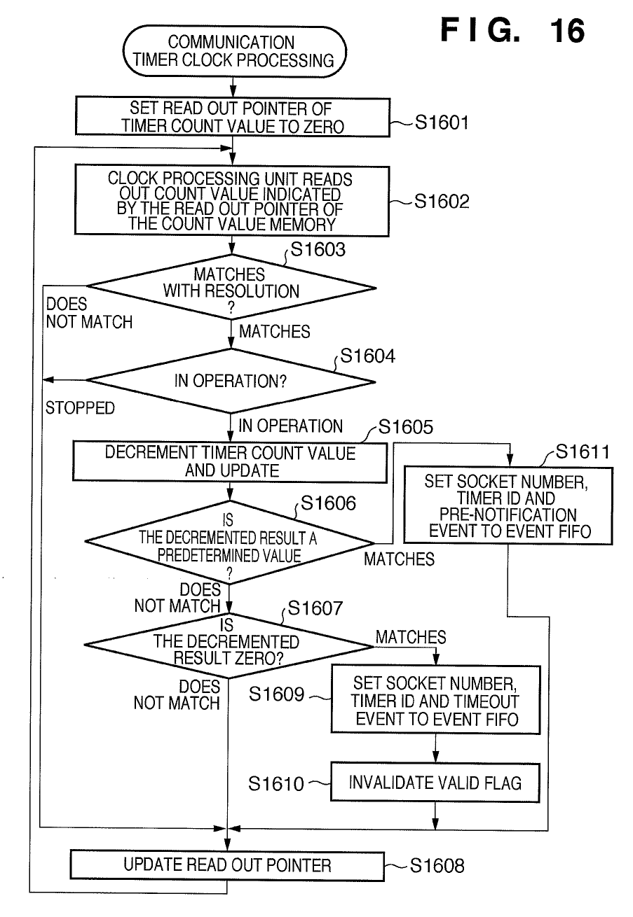

The above-described initial value memory 1106 stores initial values for each timer and for each connection, in a format shown in FIGS. 13 and 14. The resolution 1302 and time value 1303 shown in FIGS. 13 and 14 are for setting the resolution and time value for time-bases (FIG. 15) that exist in the clock processing unit 1105.

FIG. 15 depicts a diagram showing a relationship between resolutions and time values of the time-bases that reside in the time-count processing unit according to the present embodiment of the invention. The resolution 1302 is an ID that specifies a plurality of time-bases with different cycles. Further, the time value 1303 determines the range of the time-bases specified at the resolution 1302. As shown in FIG. 15, the range permitted for the time value differs according to the resolution.

By thus switching the time-base, it is possible to cover a wide period range with a small bit range. The initial value of the timer is written into the initial value memory 1106 upon establishment of the connection.

In the following, processes for initialization of the communication timer 212, and start and stop of the timer will be described using a retransfer timer as an example.

The processes for initialization of the communication timer 212 and the start and stop of the timer are controlled and executed by a finite state machine inside the timer control unit 1101 or the clock processing unit 1105, or by a sequencer equipped with a micro-program.

First, the socket number that corresponds to the connection and the initial value for each timer is conveyed from the sub-processor A201 or the main processor 101 that administers the connection upon establishment of the connection, to the timer control unit 1101 via a timer port. Thereby, an initial value is set to a predetermined position of the retransfer timer. Likewise, an initial value is set to a predetermined position of the continuation timer and the delayed acknowledgement timer.

If a transmission process is performed at socket number 1, the sub-processor C203 for performing the TCP transmission process starts the retransfer timer right after the TCP transmission process. The sub-processor C203 directs the type of the timer (timer ID: retransfer timer) and socket number 1 to the timer control unit 1101 via a timer port.

Meanwhile, the timer control unit 1101 directs the type of the timer (timer ID: retransfer timer), socket number 1, and start of the timer, to the loader 1103. The loader 1103 reads the resolution 1302 and the time value 1303 that are initial values of the retransfer timer for socket number 1 from the initial value memory 1106. Then, it sets the Valid Flag 1401 to “valid” and writes it into a location where the retransfer timer value of socket number 1 of the count value memory 1107 is stored. As will be described later, it is noted that the clock processing unit 1105 periodically reads the count value memory 1107 and only the timer values having a “valid” Valid Flag 1401 are updated.

Further, the stop of retransfer timer is done upon occurrence of a timeout and when an acknowledgement or reset segment is received. In the case when processing the stop of socket number 1, the sub-processor C203 directs the type of the timer (timer ID: retransfer timer), socket number 1, and stop of the timer, to the timer control unit 1101 via a timer port.

Meanwhile, the timer control unit 1101 directs the type of the timer (timer ID: retransfer timer), socket number 1, and stop of the timer, to the loader 1103. The loader 1103 sets the Valid Flag 1401 “invalid” and writes it into a location where the retransfer timer value of socket number 1 of the count value memory 1107 is stored.

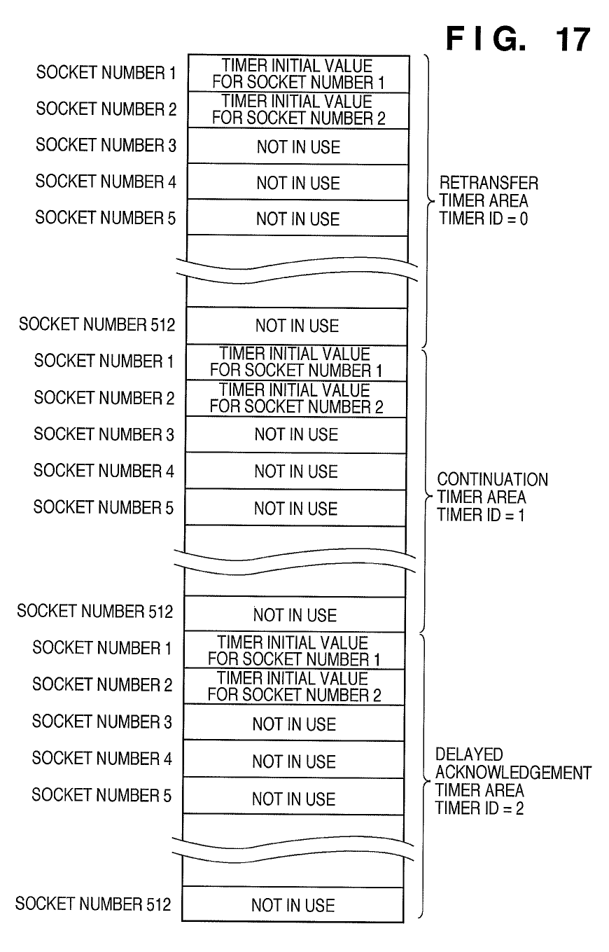

In the following, the initialization of the communication timer 212, the time-count process after the timer start process is done, and the event processing of the result will be described with reference to FIG. 16.

The time-count process is performed mainly in the clock processing unit 1105. The count value memory 1107 is referred to in each cycle of the time-base provided for each resolution 1302 inside the clock processing unit 1105 to update the count value and to write it back into the count value memory 1107. Furthermore, it generates events from the referred result, such as timeouts.

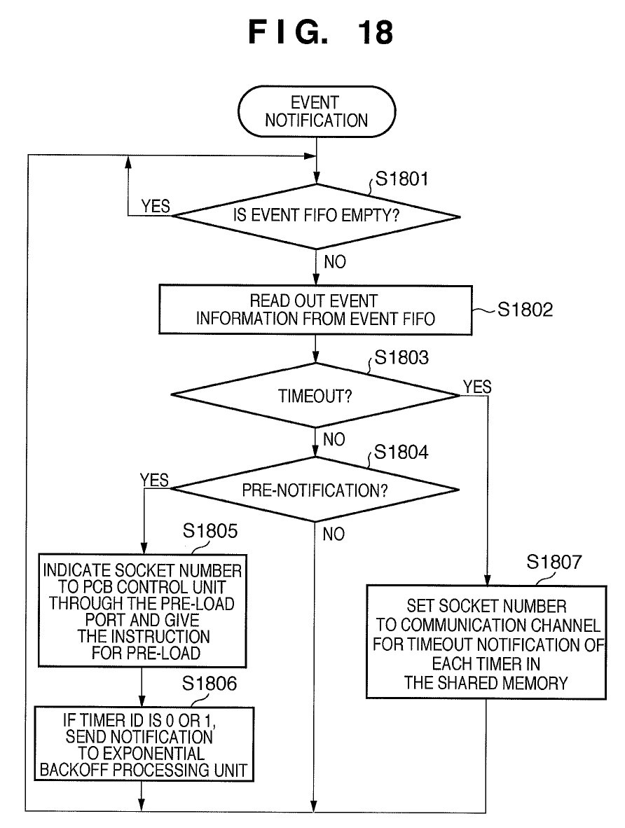

First, in step S1601, initialization of a read pointer of the count value memory 1107 is performed. As a result of this initialization, the first reference starts from the timer count value of socket number 1. It is noted that the internal arrangement of the count value memory 1107 is similar to the internal arrangement of the initial value memory 1106 shown in FIG. 17, but the timer factor value is stored instead of the initial value. However, among those, the Valid Flag 1401 for a “not-in-use” portion is initialized to zero (“invalid”).

Then, in step S1602, the clock processing unit 1105 reads the timer count value indicated by the read pointer of the count value memory 1107. Thereafter, in step S1603, whether the resolution 1302 of the read timer count value matches the time-base or not is determined. As a result of the determination, if it matches, the process proceeds to step S1604, and if it does not match, the process proceeds to step

In step S1604, whether the Valid Flag 1401 of the read timer count value is “valid” (operating) or “invalid” (stopped) is determined. If it is “valid” (operating), the process proceeds to step S1605, and if it is “invalid” (stopped), the process proceeds to step S1608. In step S1605, the time value 1303 of the read timer count value is decremented by 1, and the result thereof (hereinafter referred to as “decremented result”) is written back into the read pointer of the count value memory 1107.

Then, in step S1606, if the decremented result matches the “preset value”, the process proceeds to step S1611, and if it does not match, the process proceeds to step S1607. The “preset value” herein is a value set in a predetermined register of the timer control unit 1101 from the main processor 101 or the sub-processor A201. The clock processing unit 1105 performs the above-described comparison to refer to this register. The meaning of the value will be described later.

Then, in step S1607, if the decremented result is zero, the process proceeds to step S1609, and if it is not zero, the process proceeds to step S1608. In step S1608, the read pointer is updated by 1. However, if the update results in the read pointer exceeding the last count of the count value memory 1107, the read pointer is set back to zero. After step S1608, the process returns to step S1602.

In step S1609, the event code (timeout), and socket number and timer ID during the process are written into the event FIFO (FIG. 12) provided inside the clock processing unit 1105. Then, in step S1610, the Valid Flag 1401 of the read timer count value is set to “invalid” and is written back into the count value memory 1107.

Meanwhile, in step S1611, event code (pre-notification), and socket number and timer ID in process are written into the event FIFO provided inside the clock processing unit 1105.

In the following, how the above-described events are conveyed to the relevant portion and processed via the timer control unit 1101 will be described with reference to FIG. 18.

FIG. 18 depicts a flow chart showing an event notification process according to the present embodiment of the invention. The timer control unit 1101 examines whether the event FIFO is empty or not and monitors writing of the event information 1201. The timer control unit 1101 further monitors writing into the timer ports, etc.

In step S1801, if the event information 1201 is written into the event FIFO, the process proceeds to step S1802. In this step S1802, the event information 1201 is read from the event FIFO. Then, in step S1803, if the event code 1211 of the read event information is a timeout, the process proceeds to step S1807, and if it is not, the process proceeds to step S1804.

In this step S1804, if the event code 1211 of the read event information is pre-notification, the process proceeds to step S1805, and if it is not, the process proceeds to step S1801.

In step S1805, the timer control unit 1101 specifies the socket number to the PCB control unit 210 via a pre-load port and gives the instruction to pre-load the TCPCB. This process involves inferring the possibility of timeout of the retransfer timer (pre-detect the timeout) and is for pre-loading TCPCB needed for the retransfer process in the PCB cache memory 211 until right before the timeout occurs.

Then, in step S1806, if the timer ID is retransfer timer or persist timer, an instruction for an exponential backoff process is given to the exponential backoff processing unit 1108.

Therefore, the above-described “preset value” is set to a minimum value foreseeing completion time of the pre-load and completion time of the exponential backoff process. By thus suppressing “preset value” to a minimum, the cause of the timeout after the pre-notification is eliminated, and it is therefore possible to decrease the probability that the pre-load ends in vain

Although the retransfer timer is described as an example in the present embodiment of the invention, it is easily expected that other timers (e.g., continuance timer, delayed acknowledgement) result in a similar process.

As described above, in the TCP process, a retransfer is performed when a timeout of a retransfer timer has occurred. The retransfer timer is also started in this case, but it is recommended to equip a mechanism that doubles the timer value upon restarting to enhance the effectiveness of the timeout. This process is called “exponential backoff”. The timer control unit 1101 starts the exponential backoff processing unit 1108 simultaneously with an instruction for the aforementioned pre-load, and the exponential backoff process is performed.

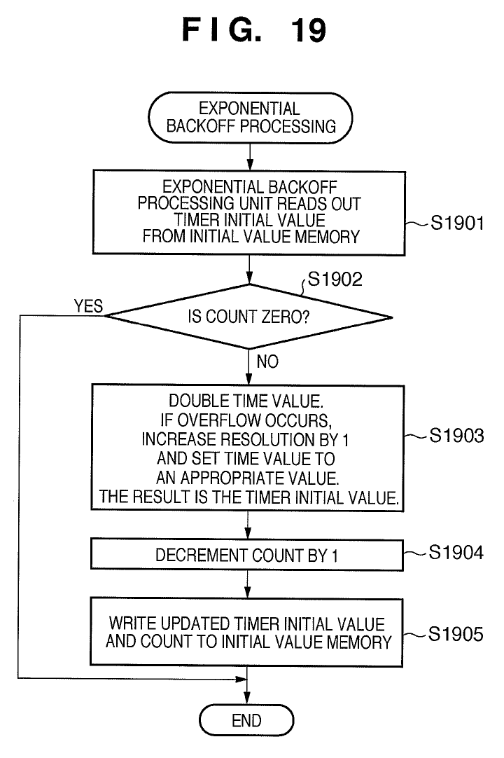

FIG. 19 depicts a flowchart showing an exponential backoff process according to the present embodiment of the invention. First, in step S1901, the exponential backoff processing unit 1108 reads the timer initial value from the initial value memory 1106.

Then, in step S1902, if the count 1301 of the read timer initial value is zero, nothing is performed and the exponential backoff process ends, but if it is not, the process proceeds to step S1903.

In step S1903, the time value 1303 of the read timer initial value is doubled. If digit overflow occurs at this time, the resolution 1302 is incremented by 1 and the time value 1303 is set to an “appropriate value”. The “appropriate value” is a value closest to the doubled value.

Then, in step S1904, the count 1301 of the read timer initial value is decremented by 1. Thereafter, in step S1905, after receiving a timeout notification from the timer control unit 1101, the exponential backoff processing unit 1108 writes the updated timer initial value (count 1301, resolution 1302, and time value 1303) into the initial value memory 1106. Here, if the timer stopped without a timeout, nothing is performed and the exponential backoff process ends.

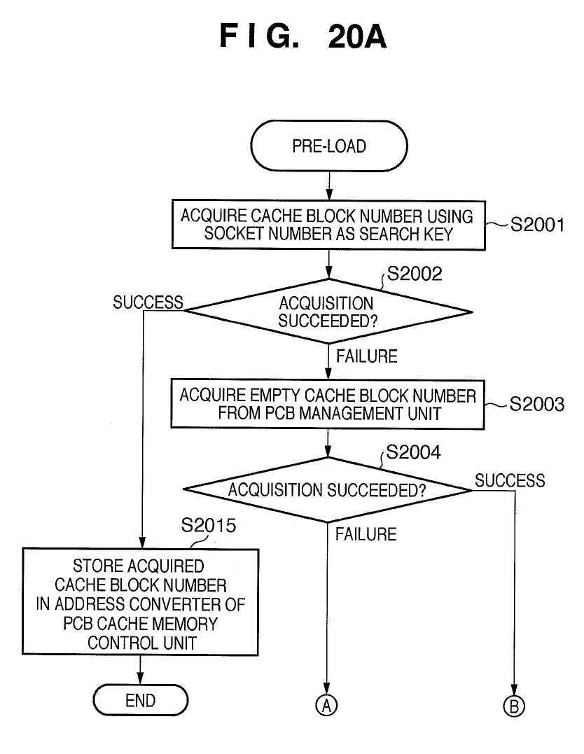

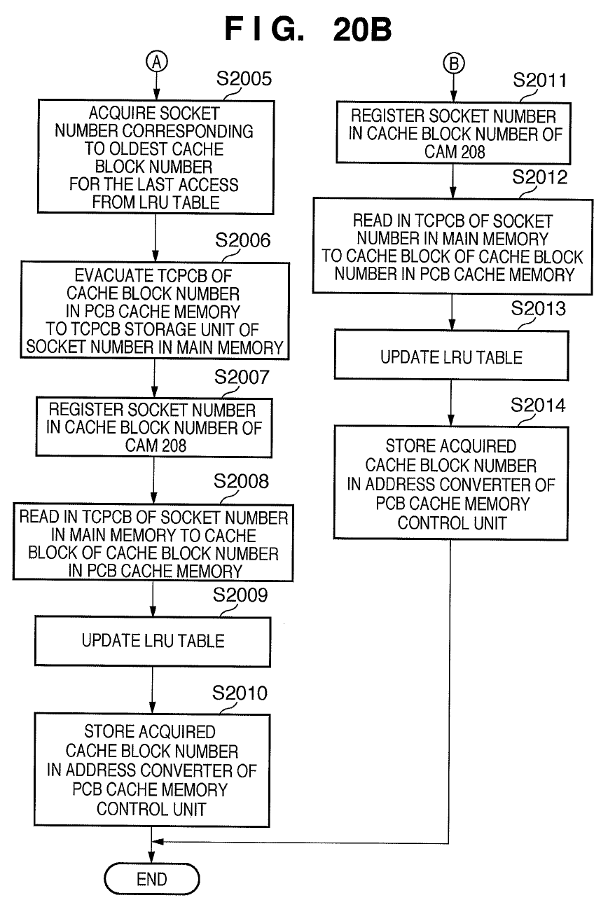

In the following, a flow in which the PCB control unit 210 processes the TCPCB upon receipt of an instruction for pre-load from the aforementioned timer control unit 1101 will be described with reference to FIGS. 20A-25. It is noted that the process shown in FIGS. 20A and 20B is controlled according to microcodes of the PCB control sequencer 402 allocated inside the PCB control unit 210.

The PCB control unit 210 is instructed to generate the TCPCB from the sub-processor A201, and socket information, etc., are conveyed from the sub-processor A201 at that time. Thereafter, it acquires a “not-in-use” socket number from the PCB management unit 406.

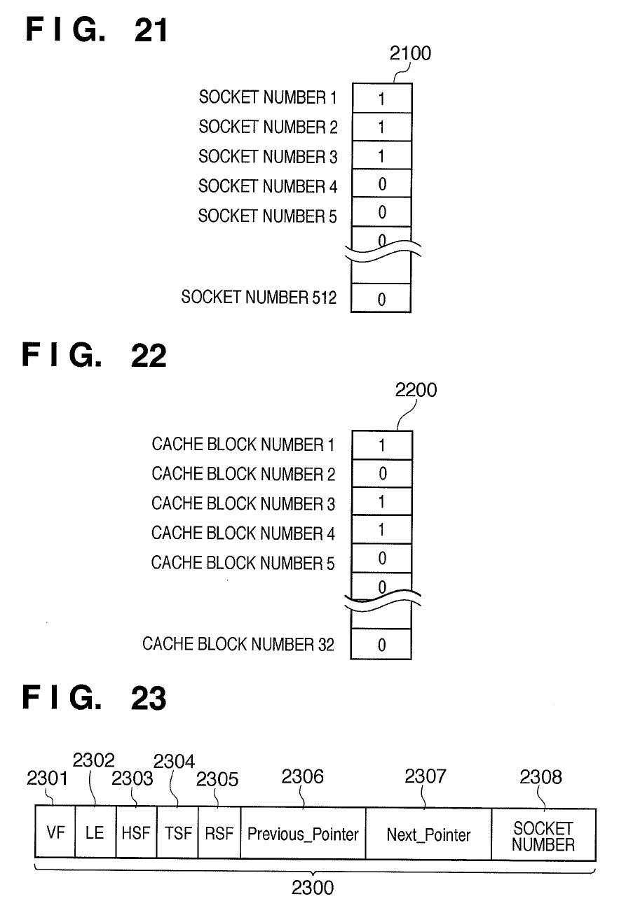

In the present embodiment of the invention, the socket number is assigned from among a series of number groups called “socket numbers” that are unique and used for identifying socket pairs. The PCB management unit 406 manages those “not-in-use” socket numbers and issues them. The PCB management unit 406 forms a bitmap 2100 (FIG. 21) that indicates use or not-in-use of the socket numbers on the PCB management unit table 405 to manage the socket numbers. FIG. 21 depicts a diagram showing a bitmap representing use/not-in-use of socket numbers allocated in a PCB management table according to the present embodiment.

Here, if a request for a not-in-use socket number is given to the PCB management unit 406 by the sub-processor A201, it reports a not-in-use socket number that was obtained in advance by searching the bitmap 2100. Besides this report, an update of the PCB management unit table 405 and a search for the next not-in-use socket number is performed as a background operation.

Further, the used socket number is returned from the sub-processor A201 to the PCB management unit 406 upon disengagement of the connection, and thereafter, the PCB management unit table 405 is updated, and a search for a not-in-use socket number is performed.

FIGS. 20A and 20B depict a flowchart showing a pre-load process according to the present embodiment of the invention. This process is a process in the PCB control unit 210 performed when the PCB control unit 210 receives an instruction for pre-load from the timer control unit 1101.

In step S2001, a cache block number is acquired using a socket number as a search key. This search involves using the aforementioned CAM 208, performing the search using the socket number as a search key, and reporting the matched cache block number.

Then, in step S2002, if the acquisition of the cache block number succeeded, the process proceeds to step S2015, and if it failed, the process proceeds to step S2003. It is noted that failure of the acquisition occurs in the case when there are no target TCPCBs in the PCB cache memory 211.

In step S2003, a vacant cache block number is acquired from the PCB management unit 406. Similarly to socket numbers, cache block numbers are managed by forming a bitmap 2200 (FIG. 22) that indicates use or not-in-use of the cache block numbers on the PCB management unit table 405. FIG. 22 depicts a diagram showing a bitmap representing use/not-in-use of cache block numbers allocated in the PCB management table according to the present embodiment of the invention.

Then, in step S2004, if the not-in-use cache block number is exhausted and acquisition failed, the process proceeds to step S2005, and if it succeeded, the process proceeds to step S2011. In step S2005, a socket number that corresponds to an oldest “last access” cache block number is acquired from the LRU table 404.

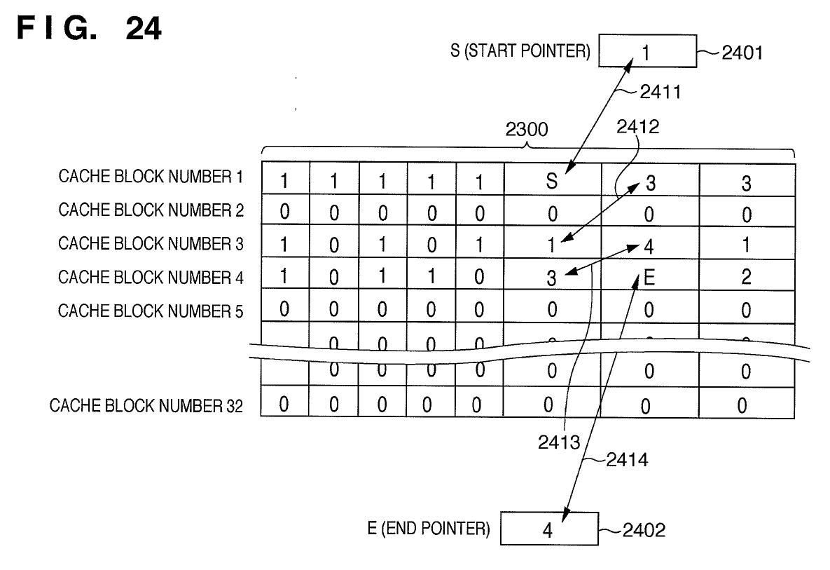

FIG. 23 depicts a diagram showing a format of concatenated blocks in an LRU table according to the present embodiment of the invention. FIG. 24 depicts a diagram showing a relationship between a format of an LRU table, and concatenated blocks, a start pointer, and an end pointer in the LRU table.

The LRU table 404 is arranged as shown in FIG. 24 in a format 2300 shown in FIG. 23. Valid cache blocks are concatenated by a start pointer 2401, an end pointer 2402, and two pieces of pointer information held by the PCB control sequencer 402. Concatenated conditions 2411-2414 of the concatenated individual cache blocks are shown by two pieces of pointer information, that is, Previous_Pointer 2306 and Next_Pointer 2307.

The start pointer 2401 indicates a cache block for head of the concatenation and the end pointer 2402 indicates a cache block for end of the concatenation. A newly generated cache block is concatenated to the near side of the end pointer 2402. The oldest cache block is a block that the start pointer 2401 indicates. Furthermore, with respect to removal of any one of cache blocks, only the Previous_Pointer 2306 and Next_Pointer 2307 for the target cache block and its neighboring front and back cache blocks need to be manipulated. Upon the manipulation, the start pointer 2401 functions as Next_Pointer and the end pointer 2402 functions as Previous_Pointer.

Other than these pointers, a flag (VF) 2301 that indicates the cache block is valid, and an evacuation lock flag (LF) 2302 that prohibits evacuation from the PCB cache memory 211 are stored in the LRU table 404. Furthermore, usage flags (HSF, TSF, RSF) 2303, 2304, 2305 that indicate which sub-processor is being used, and a relevant socket number 2308 are stored.

Updating manipulations such as registering and deleting of the LRU table 404 are performed by referring and rewriting the aforementioned pointers and flags. These manipulations are controlled according to the microcode of the PCB control sequencer 402 allocated inside the PCB control unit 210.

Then, in step S2006, the TCPCB for the cache block number on the PCB cache memory 211 is evacuated to a location for storing TCPCB for the socket number on the main memory 104. Thereafter, in step S2007, the socket number is registered at the cache block number of CAM 208. When the socket number is used as a search key for searching, the CAM 208 reports the matched cache block number. Registration into the CAM 208 involves specifying the cache block number as an address and registering the socket number.

Then, in step S2008, the TCPCB for the socket number in the main memory 104 is read into the cache block for the cache block number on the PCB cache memory 211. Thereafter, in step S2009, the LRU table 404 is updated. This update involves connecting and replacing the target cache block at near side of the end pointer 2402. The intention for this is to reduce the possibility of evacuation since it is expected that the cache block is accessed by the sub-processor B202.

Then, in step S2010, the acquired cache block number is stored in an address converter of the PCB cache memory 407.

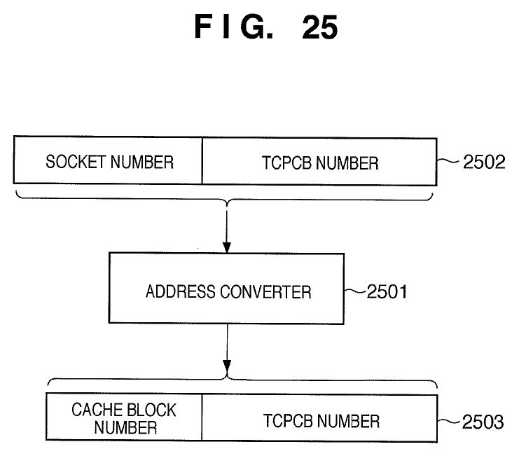

FIG. 25 depicts a diagram showing an address conversion of the PCB cache memory control unit 407 according to the present embodiment of the invention. The socket number and the TCPCB number are converted to the cache block number and the TCPCB number 2502 based on the cache block number in which the address converter 2501 is stored.

Meanwhile, in step S2011, since the acquisition of a vacant cache block number has succeeded, the socket number is registered at the acquired cache block number of CAM 208.

Then, in step S2012, the TCPCB for the socket number on the main memory 104 is read into the location of the cache block for the cache block number on the PCB cache memory 211.

Thereafter, in step S2013, the LRU table 404 is updated. Similarly to step S2009, this update involves connecting and replacing the target cache block at near side of the end pointer 2402.

Then, in step S2014, the acquired cache block number is stored in the address converter of the PCB cache memory 407.

Furthermore, in step S2015, the acquired cache block number is stored in the address converter of the PCB cache memory 407.

According to the present embodiment of the invention, if a timeout occurred in a TCP process, necessary PCBs are loaded into the primary memory (fast speed memory inside an ASIC) before the subsequent TCP process starts, thereby contributing to faster PCB access. Therefore, it is possible to reduce the TCP processing time and to lessen decreases in performance due to timeouts.

A recording medium in which program codes of software enabling functions of the aforementioned embodiment are recorded may be provided to a system or an apparatus, and a computer (CPU or MPU) of the system or the apparatus reads and executes the program codes stored in the recordable medium. Needless to say, this accomplishes the objective of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-150843, filed Jun. 9, 2008, which is hereby incorporated by reference herein in its entirety.

What is claimed is:

1. A communication apparatus for communicating based on a communication protocol, comprising:
a unit that holds and manages context information related to a connection of the communication protocol;
a unit that performs a time-count process of a timer used in the communication protocol and pre-detects a timeout of the timer; and
a unit that instructs a pre-load such that the context information is stored in a cache memory in a case where the timeout is pre-detected.

2. The apparatus according to claim 1, further comprising a control unit that controls storage into the cache memory, and
wherein the control unit controls such that a cache memory with oldest last access is used for the storing in a case where the cache memory is not capable of the storing.

3. A method of controlling a communication apparatus for communicating based on a communication protocol, comprising:
holding and managing context information concerning a connection of the communication protocol;
performing a time-count process of a timer used in the communication protocol and pre-detecting a timeout of the timer; and
instructing a pre-load such that the context information is stored in a cache memory in a case where the timeout is pre-detected.

4. A program for enabling a computer to execute the method of controlling a communication apparatus according to claim 3, which is recorded in a recording medium capable being read by a computer.

5. A recording medium capable of being read by a computer, in which the program according to claim 4 is recorded.
